(19) United States
(12) Patent Application Publication
(10) Pub. No.: US 2011/0097077 A1
(43) Pub. Date: Apr. 28, 2011

(54) OPTICAL TRANSMISSION SYSTEM

(75) Inventors: TAKAYUKI SUZUKI, Yokohama (JP); Takuya Iwasawa, Kawasaki (JP); Kenta Noda, Yokohama (JP)

(73) Assignee: Hitachi, Ltd.

(21) Appl. No.: 12/907,659

(22) Filed: Oct. 19, 2010

(30) Foreign Application Priority Data
Oct. 23, 2009 (JP) 2009-243980

(51) Int. Cl. H04B 10/02

(52) U.S. Cl. 398/5

(57) ABSTRACT

A redundant optical transmission system for transmitting a gigabit Ethernet signal is disclosed. The system includes network devices having the auto negotiation function and transponders having the auto negotiation function based on the Ethernet standard. Upon occurrence of a fault in the optical signal path, a line fault such as the link disconnection with a network device is detected and the corresponding information is transferred to the opposite station. The opposite station restarts the auto negotiation with the network device, thereby positively repairing the line disconnection between the network devices.

### INCORPORATION BY REFERENCE

The present application claims priority from Japanese application JP2009-243980 filed on Oct. 23, 2009, the content of which is hereby incorporated by reference into this application.

### BACKGROUND OF THE INVENTION

This invention relates to a method of controlling a transmission device having the auto negotiation function based on the Ethernet (registered trademark) standard, or in particular, to a method of repairing a line disconnection which may occur between network devices through the transmission device at the time of a fault in a redundant optical transmission system using an optical switch.

In the optical transmission system, a method of switching two optical signal paths by an optical switch upon occurrence of a fault finds practical application as a means to minimize the adverse effect of a communication failure between the network devices due to a fault which may occur on an optical signal path.

As an actual example using an optical switch, JP-A-2003-338788 has been proposed. In the example of the method described in JP-A-2003-338788, the optical signal output from an optical transmission circuit of a primary device is rendered to diverge into two optical transmission paths by an optical multiplexer/demultiplexer, and one of the optical signals is selected by the optical switch of a secondary device. In the case where the optical transmission path selected by the optical switch develops a fault, a light receiving circuit detects the disconnection of the optical signal, and by instructing a switch control circuit to switch the optical switches, the remaining optical transmission path is selected.

### SUMMARY OF THE INVENTION

As a configuration similar to that of JP-A-2003-338788, the configuration shown in FIG. 5 is considered. In FIG. 5, assume that a fault occurs in the optical signal path on the input side of an active transponder 105 between a light diverging switch 103 and the active transponder 105 (step 1). The disconnection of the optical line is notified to the active transponder of a station B (step 2), and the output to the light diverging switch 104 is stopped (step 3). The light diverging switch 104 detects the disconnection of the optical signal input and turns the switch to the spare system (step 4). In the configuration shown in FIG. 5, the optical signal from a network device 101 of a station A is led to the network device 102 of the station B through the optical signal path of the spare system. The optical signal from the network device 102 of the station B, on the other hand, is led to the network device 101 of the station A through the optical signal path of the active system. As a result, the mutual communication between the network devices 101, 102 is established through different paths.

In an optical transmission system for transmitting the Gigabit Ethernet signal and having the configuration shown in FIG. 5, assume the use of a network device having the auto negotiation function and a transponder having the auto negotiation function. In such a case, the optical signal path may not be switched properly and the communication may continues to be disconnected between the network devices at the time of occurrence of a fault.

In the configuration shown in FIG. 5, for example, assume that a fault occurs in the optical signal path on the input side of the light diverging switch 103 of the station A between the particular light diverging switch 103 and the active transponder 105. The link between the active transponder 105 and the network device 101 is disconnected, and the light diverging switch 103 switches the operation to the spare system by detecting the disconnection of the optical input signal. The communication between the network device 101 and the spare transponder 106 becomes possible after the link is established by auto negotiation. The light diverging switch 104 of the station B, on the other hand, continues to select the active optical path for lack of any reason for switching. In this case, as the optical signal path after switching, the optical signal from the network device 101 of the station A is expected to be led to the network device 102 of the station B through the spare system path, and the optical signal from the network device 102 of the station B to be led to the network device 101 of the station A through the path of the active system. In order to transmit the optical signal using the optical path of the spare system, however, the link between the network device of the station B and the spare transponder is required to be positively established at the time of fault occurrence.

According to an example of this invention, there is provided an optical transmission system comprising:

a first network including a first network device, a first transponder, a second transponder and a first controller arranged between the first network device and the first and second transponders; and

a second network including a second network device, a third transponder, a fourth transponder and a second controller arranged between the second network device and the third and fourth transponders, the second network being connected to the first transmission device through an optical transmission path;

wherein the first network device, the second network device, the first transponder, the second transponder, the third transponder and the fourth transponder each have the auto negotiation function based on the Ethernet standard;

wherein the first transponder, upon reception of a line fault notification from the third transponder, transmits an auto negotiation request signal to the first network device through the first controller; and

wherein the second transponder, upon transmission of the auto negotiation request signal from the first transponder, receives the auto negotiation request signal from the first network device through the first controller thereby to set a link with the first network device.

An optical transmission system forming a redundant system using an optical switch can use a network device having the auto negotiation function and a transponder having the auto negotiation function based on the Ethernet standard. Then, the line disconnection between the network devices upon occurrence of a fault on the optical signal path can be positively repaired.

Other objects, features and advantages of the invention will become apparent from the following description of the embodiments of the invention taken in conjunction with the accompanying drawings.

### BRIEF DESCRIPTION OF THE DRAWINGS

FIG. 1 shows an example of the configuration of the optical transmission system according to the invention.

FIG. 2 shows an example of operation upon occurrence of a fault in the optical transmission system according to the invention.

FIG. 3 shows an example of a sequence flowchart of steps 1 to 5-b shown in FIG. 2.

FIG. 4 shows another example of operation upon occurrence of a fault in the optical transmission system according to the invention.

FIG. 5 shows an example of the configuration of an optical transmission system.

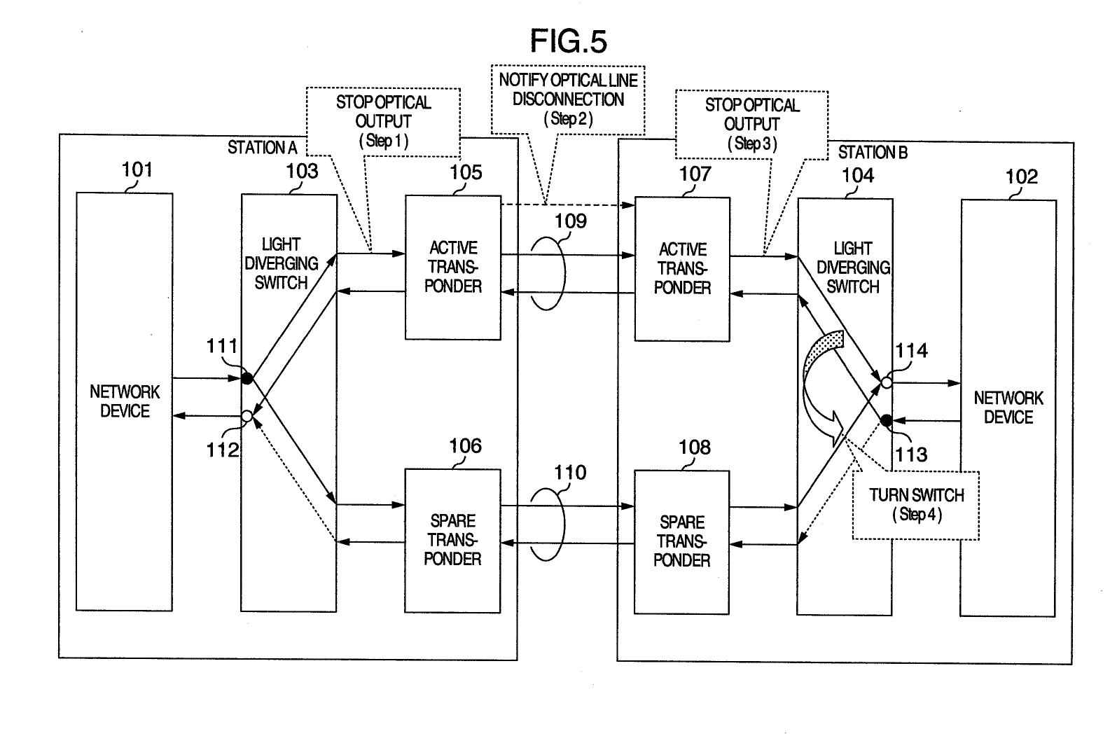

### DETAILED DESCRIPTION OF THE INVENTION

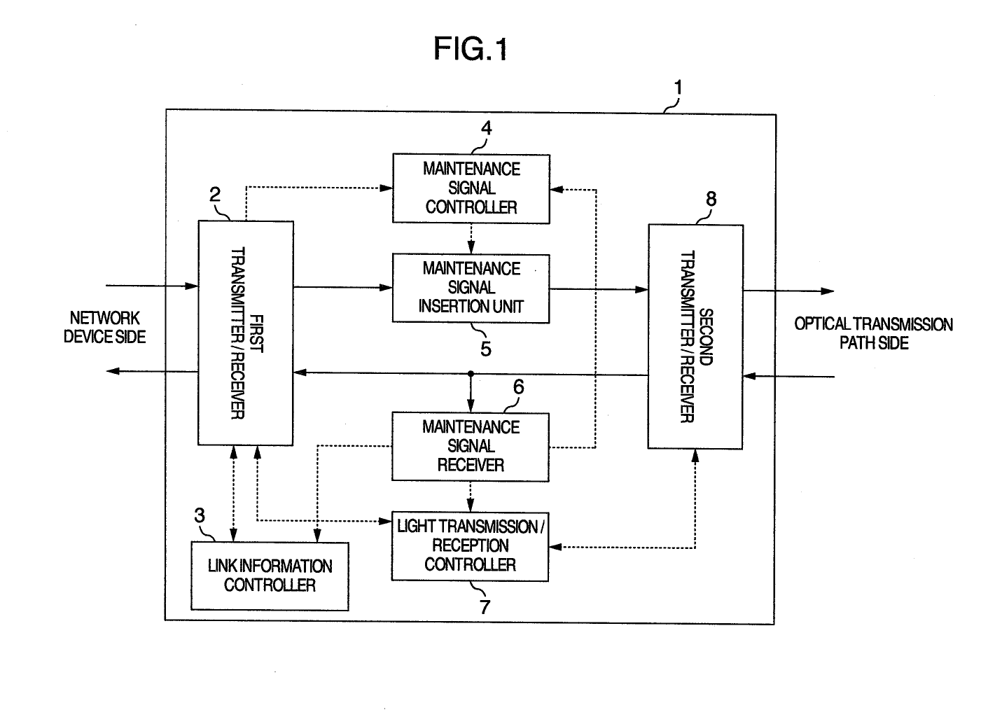

FIG. 1 is a diagram showing an example of internal blocks of a transponder according to the invention. The transponder is configured of a first light transmitter/receiver 2 for transmitting/receiving the optical signal to and from a network device, a link information controller 3 for communicating with the network device to control the auto negotiation, a maintenance signal insertion unit 5 for controlling the transmission of a maintenance signal to a corresponding transponder, a maintenance signal controller 4 for determining the data pattern of the maintenance signal and controlling the maintenance signal insertion unit, a second light transmitter/receiver 8 for transmitting/receiving the optical signal to and from a corresponding transponder through an optical transmission path, a maintenance signal receiver 6 for receiving the maintenance signal, and a light transmission/reception controller 7 for controlling the first and second light transmitter/receivers. The light transmission/reception controller 7 controls the first light transmitter/receiver 2 to stop the output of the optical signal to the network device at the time of detecting the disconnection of the optical signal input from the network device by the first optical transmitter/receiver 2.

The maintenance signal controller 4, upon detection of a line fault (such as the disconnection of the optical signal) input from a network device by the first optical transmitter/receiver 2, controls the maintenance signal insertion unit 5 in such a manner as to transmit the first maintenance signal containing the information on the line fault to a corresponding transponder as a notice. The light transmission/reception controller 7 controls the first light transmitter/receiver 2 to stop the output of the optical signal to the network device at the time of receiving the first maintenance signal transferred thereto through the optical transmission path by the maintenance signal receiver 6.

The maintenance signal controller 4, upon detection of the disconnection of the link with the network device by the link information controller 3, controls the maintenance signal insertion unit 5 to transmit the second maintenance signal having the link disconnection information to the corresponding transponder.

The link information controller 3, upon reception of the second maintenance signal transferred thereto through the optical transmission path by the maintenance signal receiver 6, carries out the auto negotiation with the network device by outputting an auto negotiation restart signal to the network device.

The maintenance signal controller 4, upon detection of the link establishment through the auto negotiation by the link information controller 3, controls the maintenance signal insertion unit 5 in such a manner as to transmit a third maintenance signal indicating the response to the second maintenance signal to the corresponding transponder. The maintenance signal controller 4, upon reception of the third maintenance signal by the maintenance signal receiver 6 through the optical transmission path, controls the maintenance signal insertion unit 5 to stop the output of the second maintenance signal. As a result, the optical signal from the network device is passed to the optical transmission path.

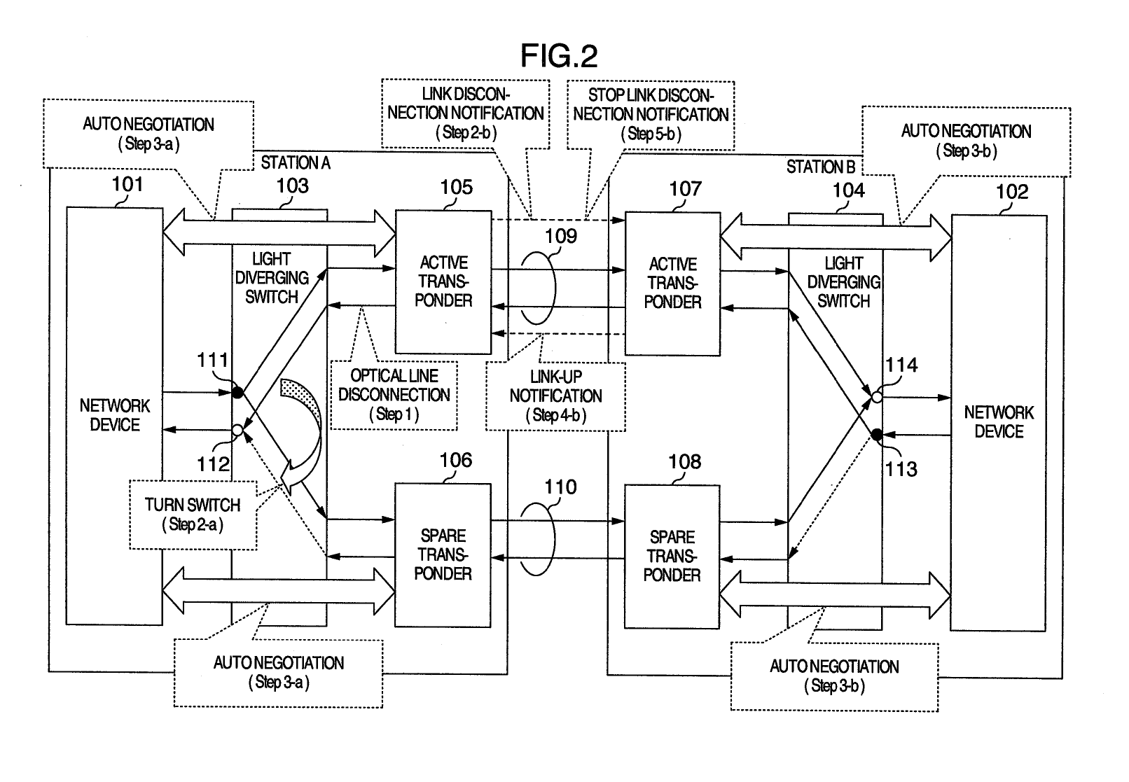

FIG. 2 shows an example of the configuration of the optical transmission system using the transponders according to the invention for explaining an example of the operation thereof. Each example of the operation is described in a dashed column with the link disconnection as a line fault. The system shown in FIG. 2 is intended to transmit the optical signals of the network devices between two stations and configured as a redundant system having double transponders and double transmission paths. In FIG. 2, the station A is a communication network station house installed with a network device 101, a light diverging switch 103 and transponders 105, 106, while the station B arranged in opposed relation to the station A is a communication network station house installed with a network device 102, a light diverging switch 104 and transponders 107, 108. Also, the light diverging switches 103, 104 are controllers for controlling the path of the optical signal, and arranged between the network device 101 and the transponders 105, 106 and between the network device 102 and the transponders 107, 108, respectively. The optical signals output from the network devices 101, 102, as shown in FIG. 2, are each rendered to diverge into two paths by optical couplers 111, 113 in the light diverging switches 103, 104, and after signal conversion by the transponders 105 to 108, led to the optical transmission paths 109, 110, respectively. The optical signals that have passed through the double optical transmission paths 109, 110, after signal conversion in the transponders 105 to 108, are selected as a signal from either an active system or a spare system by optical switches 112, 114 in the light diverging switches 103, 104. In the case where a fault occurs on the optical signal path on the input side of the light diverging switch 103 between the light diverging switch 103 and the active transponder 105 of the station A (step 1), the link between the active transponder 105 and the network device 101 is disconnected, and the optical switch 112 in the light diverging switch 103, by detecting the disconnection of the optical signal, changes over to the spare system (step 2-a). In the process, the network device 101 and the active transponder 105, due to the link disconnection therebetween, transfer to the initial state of auto negotiation. On the other hand, the spare transponder 106 which starts the communication in two ways with the network device 101 due to the change-over operation also receives the signal output by the network device 101 in the initial stage of auto negotiation, and transfers to the initial state of auto negotiation. Next, the spare transponder 106 carries out the auto negotiation by communication with the network device 101 (step 3-a) and establishes the link. In the process, the active transponder 105 receives the optical signal from the network device 101 through the optical coupler 111 in the light diverging switch 103, and by transmitting a response signal in return, behaves in the same manner as if to carry out the auto negotiation with the network device 101 in harmony with the auto negotiation carried out between the spare transponder 106 and the network device 101 (descried as the auto negotiation in step 3-a). As a result, the active transponder 105 establishes a link with the network device 101 in an auxiliary manner.

The active transponder 105, on the other hand, upon detection of the link disconnection with the network device 101 due to the disconnection of the optical line in step 1, transfers the link disconnection information to the active transponder 107 of the station B to notify the link disconnection as a line fault using the first maintenance signal (step 2-b). The data pattern of the first maintenance signal is not used in the normal signal transmission. Although the 8B10B code is used in the Ethernet, for example, there exists a data pattern not generated by the 8B10B code rule, and by using such a data pattern for the maintenance signal, the discrimination from the normal data signal is made possible.

The active transponder 107 of the station B that has received the link disconnection information as the first maintenance signal requests the network device 102 to restart the auto negotiation, so that the active transponder 107 and the network device 102 are transferred to the initial state of auto negotiation.

On the other hand, the spare transponder 108 connected to the network device 102 through the optical coupler 113 in the light diverging switch 104 is also transferred to the initial state by receiving the signal output from the network device 102 in the initial state of auto negotiation. Next, the active transponder 107 carries out the auto negotiation by communicating with the network device 102 (step 3-b) and establishes the link. In the process, the spare transponder 108 receives the optical signal output from the network device 102 during the auto negotiation, and by returning a signal as a response to the optical signal, behaves in the same manner as if the auto negotiation is carried out with the network device 102 in harmony with the auto negotiation between the active transponder 107 and the network device 102 (step 3-b). As a result, the spare transponder 108 establishes the link with the network device 102 in an auxiliary manner.

The active transponder 107, after establishing the link with the network device 102, transfers the link establishment information to the active transponder 105 of the station A using the second maintenance signal (step 4-b). The data pattern of the second maintenance signal can be discriminated from that of the first maintenance signal by using a data pattern different from that of the first maintenance signal for transfer of the link disconnection information described above. The active transponder 105 that has received the link establishment information stops the transfer of the first maintenance signal and outputs the optical signal from the network device 101 of the station A to the optical transmission path 109 (step 5-b).

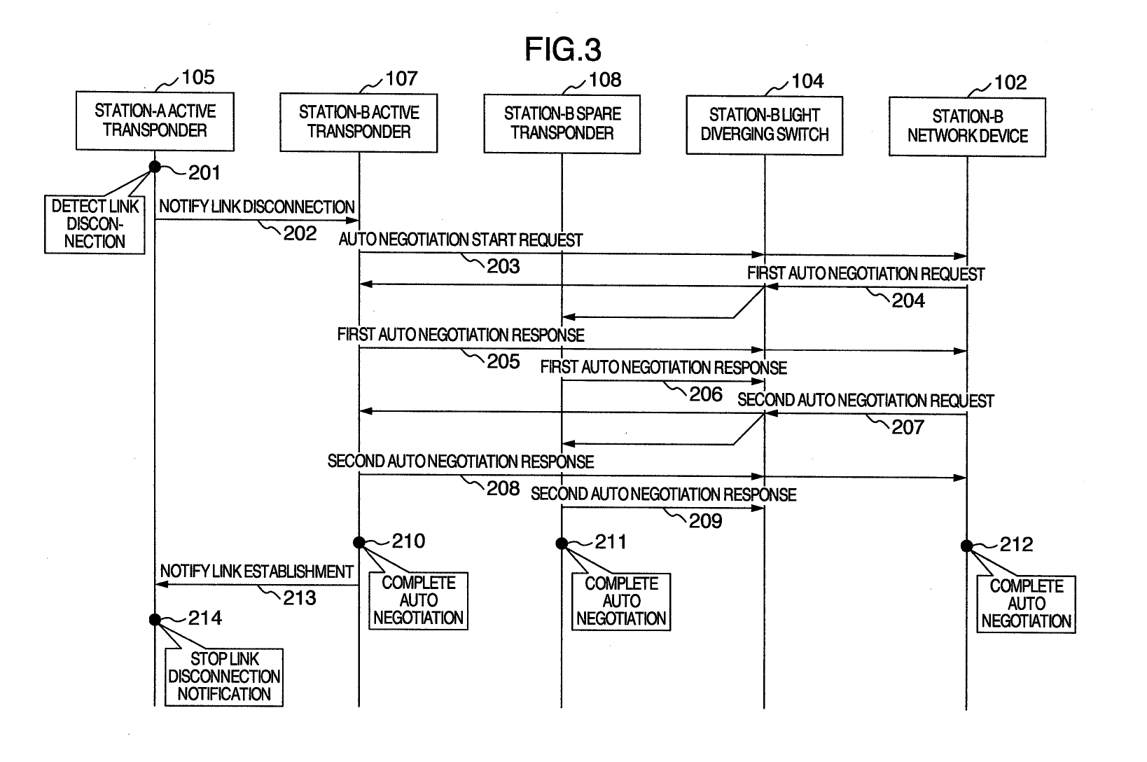

FIG. 3 is a sequence diagram for steps 1 to 5-b in the embodiment shown in FIG. 2. In FIG. 3, the sequence before link establishment is shown in simplified fashion in which the auto negotiation based on the Ethernet standard is carried out between the network device 102 and the active transponder 107/the spare transponder 108 in step 3-b.

The active transponder 105 of the station A, upon detection of a link disconnection (201), transfers the link disconnection information to the active transponder of the station B through the first maintenance signal (202). The active transponder 107 of the station B that has received the link disconnection information transmits an auto negotiation start request signal to the network device 102 through a switch 114 in the light diverging switch 104 (203). The network device 102 that has received the auto negotiation start request signal transmits one part of a first auto negotiation request signal diverged through the optical coupler 113 in the light diverging switch 104 to the active transponder 107, and the other part thereof to the spare transponder 108 (204). The active transponder 107 that has received the first auto negotiation request signal transmits a first auto negotiation response signal to the network device 102 through the optical switch 114 in the light diverging switch 104 (205). The spare transponder 108 that has received the first auto negotiation request signal, like the active transponder 107, transmits the first auto negotiation response signal to the light diverging switch 104 (206). The network device 102 that has received the first auto negotiation response signal from the active transponder 107 then transmits, through the optical coupler 113 in the light diverging switch 104, one part of a second auto negotiation request signal to the active transponder 107, and the other part thereof to the spare transponder 108 (207). The active transponder 107 that has received the second auto negotiation request signal, transmits through the optical switch 114 in the light diverging switch 104, the second auto negotiation response signal to the network device 102 (208), so that the auto negotiation is completed and the link established (210). The spare transponder 108 that has received the second auto negotiation request signal, like the active transponder 107, transmits the second auto negotiation response signal to the light diverging switch 104 (209) so that the auto negotiation is completed and the link established (211). The network device 102 that has received the second auto negotiation response signal from the active transponder 107 completes the auto negotiation and establishes the link (212). As described above, even in the case where the optical switch 114 in the light diverging switch 104 selects the active system, the spare transponder 108 can carry out the auto negotiation with the network device 102 and establish the link by receiving the request signal from the network device 102 for the response signal of the active transponder 107.

Next, the active transponder 107 that has established the link transfers the link establishment information by the second maintenance signal to the active transponder 105 of the station A (213). The active transponder 105 that has received the link establishment information stops the transmission of the first maintenance signal (214).

According to the embodiment shown in FIG. 2, the optical signal from the network device 101 of the station A is led to the network device 102 of the station B through the optical signal path of the active system. The optical signal from the network device 102 of the station B, on the other hand, is led to the network device 101 of the station A through the optical signal path of the spare system. As a result, the two-way communication between the network devices 101, 102 is established through different paths, respectively.

In the redundant optical transmission system using the transponders according to the embodiment of the invention shown in FIG. 2, the transponders of the active and spare systems of the two stations establish the link and secure the communication path by auto negotiation with the corresponding network device at the time of a fault in the optical signal path. Even in the case where the transponder of the spare system is added after starting the active operation, therefore, the line disconnection, if any, between the network devices at the time of a fault can be quickly repaired.

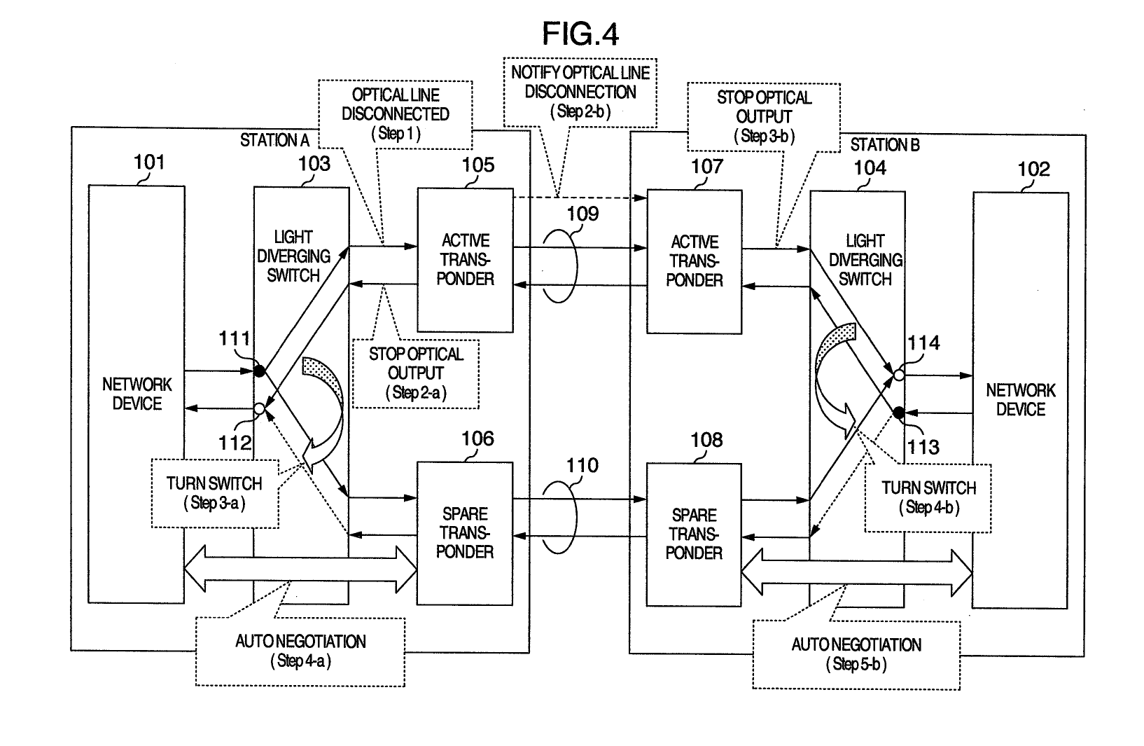

FIG. 4 is a diagram showing another example of the optical transmission system using the transponders according to the invention with the description of an operation example thereof. The operation example is described in each dashed column with the optical circuit disconnected as a line fault. The system shown in FIG. 4 transmits the optical signals of the network devices between two stations and has a similar basic configuration to FIG. 2. In the case where a fault occurs in the optical signal path on input side of the active transponder 105 between the optical diverging switch 103 and the active transponder 5 of the station A (step 1), the active transponder 105 detects the disconnection of the optical signal and stops the optical output of the light diverging switch 103 (step 2-a). Also, the link between the active transponder 105 and the network device 101 is disconnected, and the light diverging switch 103, by detecting the disconnection of the optical signal, turns the switch to the spare system (step 3-a). Next, the transponder 106 of the spare system establishes the link by auto negotiation in communication with the network device 101 (step 4-a).

On the other hand, the active transponder 105 of the station A, upon detection of the disconnection of the optical signal as the result of disconnection of the optical line in step 1, transfers the optical line disconnection information to notify the optical line disconnection as a line fault to the active transponder 107 of the station B using the third maintenance signal (step 2-b). The data pattern not used in the normal signal transmission is used for the third maintenance signal. Although Ethernet uses the 8B10B code, for example, a data pattern not generated according to the 8B10B code rule exists, and by using this data pattern for the maintenance signal, the maintenance signal can be discriminated from the normal data signal.

The active transponder 107 of the station B that has received the optical line disconnection information by the third maintenance signal stops the optical output of the network device 102 (step 3-b). As a result, the link between the active transponder 107 and the network device 102 is disconnected, and the light diverging switch 104, by detecting the disconnection of the optical signal, turns the switch to the spare system (step 4-b). Next, the spare transponder 108 carries out the auto negotiation in communication with the network device 102 thereby to establish the link (step 5-b).

According to the embodiment shown in FIG. 4, the optical signal from the network device 101 of the station A is led to the network device 102 of the station B through the optical signal path of the spare system. Also, the optical signal from the network device 102 of the station B is led to the network device 101 of the station A through the signal path of the spare system.

In the redundant optical transmission system using the transponders according to the embodiment of the invention shown in FIG. 4, the transponders of the active and spare systems of the two stations establish the link and secure the communication path by auto negotiation with the corresponding network device at the time of a fault occurrence in the optical signal path. Even in the case where the transponder of the spare system is added after starting the active operation, therefore, the line disconnection which may occur between the network devices at the time of a fault occurrence can be quickly repaired.

It should be further understood by those skilled in the art that although the foregoing description has been made on embodiments of the invention, the invention is not limited thereto and various changes and modifications may be made without departing from the spirit of the invention and the scope of the appended claims.

1. An optical transmission system comprising:
a first network including a first network device, a first transponder, a second transponder and a first controller arranged between the first network device and the first transponder/the second transponder; and
a second network including a second network device, a third transponder, a fourth transponder and a second controller arranged between the second network device and the third transponder/the fourth transponder, the second network being connected to the first network device through an optical transmission path;
wherein the first network device, the second network device, the first transponder, the second transponder, the third transponder and the fourth transponder each has the auto negotiation function based on the Ethernet standard;
wherein the first transponder, upon reception of a line fault notification from the third transponder, transmits an auto negotiation request signal to the first network device through the first controller; and
wherein the second transponder, upon transmission of the auto negotiation request signal from the first transponder, receives the auto negotiation request signal from the first network device through the first controller thereby to set a link with the first network device.

2. The optical transmission system according to claim 1,
wherein the first controller has a first optical coupler and a first optical switch, and transmits an auto negotiation request signal received from the first transponder to the first network device through the first optical switch; and
wherein the auto negotiation request signal received from the first network device is diverged by the first optical coupler and one of the diverged light is transmitted to the second transponder.

3. The optical transmission system according to claim 2,
wherein the second controller has a second optical switch which, upon occurrence of a line fault between the second controller and the third transponder, switches the connection from the third transponder to the fourth transponder; and
wherein the optical signal from the first network device is diverged by the first optical coupler and transmitted to the second network device through the second transponder, the fourth transponder and the second optical switch.

4. The optical transmission system according to claim 3,
wherein the second controller further includes a second optical coupler; and
wherein the optical signal from the second network device is diverged by the second optical coupler and transmitted to the first network device through the third transponder, the first transponder and the first optical switch.

5. The optical transmission system according to claim 3,
wherein the second controller further includes a second optical coupler; and
wherein the first optical switch changes the connection from the first transponder to the second transponder in the case where the third transponder transmits the line fault notification to the first transponder; and
wherein the optical signal from the second network device is diverged by the second optical coupler and transmitted to the first network device through the fourth transponder, the second transponder and the first optical switch.

6. The optical transmission system according to claim 1,
wherein the line fault notification is that of the link disconnection between the second controller and the third transponder.

7. The optical transmission system according to claim 1,
wherein the line fault notification is that of the disconnection of the optical line between the second controller and the third transponder.

8. The optical transmission system according to claim 1,
wherein each of the first transponder and the second transponder includes a first transmitter/receiver for communicating with the first network device, a second transmitter/receiver for communicating with the second network device through the optical transmission path, a link information controller for controlling the auto negotiation function in communication with the first network device through the first transmitter/receiver, and a signal controller for controlling the transmission of a notice containing the line fault information to the second network device.

9. The optical transmission system according to claim 8,
wherein the signal controller transmits the notice containing the line fault information through a maintenance signal.

10. The optical transmission system according to claim 8,
wherein the signal controller generates the notice containing the line fault information using a data pattern not generated according to the 8B10B code rule.
